(19) United States
(12) Patent Application Publication
(10) Pub. No.: US 2022/0111407 A1
(43) Pub. Date: Apr. 14, 2022

(54) ELECTROSTATIC SPRAYING DEVICE AND ELECTROSTATIC SPRAYING METHOD

(71) Applicant: Taicang Jingang Plant Protection Machinery & Technology Co., Ltd., Taicang, Jiangsu (CN)

(72) Inventor: Weiguo SHEN, Taicang, Jiangsu (CN)

(21) Appl. No.: 17/617,786

(22) PCT Filed: Jul. 1, 2020
(86) PCT No.: PCT/CN2020/099613

§ 371 Date: Dec. 9, 2021

(30) Foreign Application Priority Data
May 29, 2020 (CN) 202010473435.3
May 29, 2020 (CN) 202020948136.6

(51) Int. Cl. B05B 5/053; B05B 5/035

(52) U.S. Cl. CPC B05B 5/0537; B05B 5/035; B05B 5/0535

(57) ABSTRACT

The present invention provides an electrostatic spraying device and an electrostatic spraying method. The electrostatic spraying device includes: a high-voltage electrostatic generator configured for generating high-voltage static electricity and including a positive output terminal and a negative output terminal; a charging electrode connected to the positive output terminal or the negative output terminal of the high-voltage electrostatic generator and configured for directly contacting a liquid to be sprayed and applying electrostatic charges to the liquid to be sprayed; and an ionizing emitting electrode connected to the negative output terminal or the positive output terminal of the high-voltage electrostatic generator and configured for ionizing the surrounding air to realize an ionizing grounding.

### TECHNICAL FIELD

The present invention relates to the field of electrostatic spraying, and in particular to an electrostatic spraying device and an electrostatic spraying method.

### BACKGROUND

Electrostatic sprayer refers to a sprayer that enables sprayed droplets to be significantly electrostatically adsorbed all over a target. Electrostatic spraying has a series of merits such as water saving, medicine saving, high efficiency and environmental protection, and is praised as the ultimate technology of agricultural spraying. To ensure the sprayed droplets to be significantly electrostatically adsorbed all over the target, it is necessary to endow a liquid with electrostatic charges of one polarity while provide the target with electrostatic charges of another polarity by certain measures. That is, a ground electrode is required to be arranged to conduct the high-voltage electrostatic charges that have another polarity and are output by a high-voltage generator to the target through the ground electrode, so that the target is charged with the electrostatic charges of another polarity, thus forming an active electrostatic field with a closed current loop centered on the high-voltage electrostatic generator. In this way, when the sprayed charged droplets with electrostatic charges of one polarity drift close to the target with electrostatic charges of another polarity under multiple actions of gravity, gravitational attraction, and electric-field force, the dynamic charged droplets will quickly rush to the static target and firmly adhere to the upper, lower, left, and right of the target due to mutual attraction of charges with different polarities, so as to achieve the effect of droplet electrostatic adsorption all over the target.

Practice has proved that if the ground electrode is not set, that is, there is no active electrostatic field with a closed current loop, even if the sprayed droplets also carry electrostatic charges of one polarity, the sprayed droplets are difficult to be electrostatically adsorbed all over the target. While when the ground electrode is provided to form an active electrostatic field with a good closed current loop, the droplets easily and obviously undergo an electrostatic adsorption all over the target.

In order to achieve a good all-over adsorption effect of electrostatic spraying, various direct-connection grounding techniques are used in the prior art:

For a backpack electrostatic sprayer, electrostatic charges of one polarity output under high voltage by a generator directly contact skin of human hand through a metal electrode connected by wires, so that the electrostatic charges are transferred to the human body, and then conducted to a target on the ground since human feet are connected to the ground in a conducting state. Thus, the target is endowed with the electrostatic charges of one polarity.

For an electrostatic sprayer equipped with a metal frame, electrostatic charges of another polarity output under high voltage by a generator are directly connected to the metal frame through wires, and then conducted to a target on the ground since the metal frame and metal wheels thereon are connected to the ground in a conducting state. Thus, the target on the ground is endowed with the electrostatic charges of another polarity.

Through the above-mentioned grounding methods, an effective closed current loop of electrostatic spraying is indeed formed, and the all-over adsorption effect of electrostatic spraying is well achieved. However, many shortcomings and deficiencies of these methods have been discovered in practice use:

Grounding directly through human body readily produces static electricity that may irritate human body to feel uncomfortable, and results in weakened electrostatic charges or even no electrostatic charges conducted to the target due to the fact that the skin of human hand does not well contact the electrode or soles of shoes worn are made of highly insulating materials, which leads to an unstable all-over electrostatic adsorption effect.

Grounding by a direct connection to the metal frame, since the entire metal frame will be charged with high-voltage electrostatic charges, easily causes interference with other electrical components installed on the frame, water pipelines with electrostatic charges of another polarity, and water pump. As such, the difficulty of insulating treatment on related components is increased, and electrostatic charges of positive and negative polarities are highly likely to offset each other, thereby greatly affecting a good implementation of all-over electrostatic adsorption effect of spray. At the same time, it also brings the risk of electrostatic stimulation to technicians operating on the frame.

Since the grounding techniques achieved by a direct contact manner have the above-mentioned drawbacks and problems in practical use, it is very necessary and vital to develop and design a new grounding technique to solve the problems and deficiencies described above, which can ensure the stable implementation of all-over adsorption effect of electrostatic spraying, and meanwhile better guarantee safety and comfort of operators.

### SUMMARY

In order to solve the technical problems described above, the present invention discloses an electrostatic spraying device and an electrostatic spraying method, which ionizes the surrounding air through the discharge of a high-voltage ionizing electrode to achieve an ionizing grounding, and thus replaces the traditional direct-contact grounding method.

To achieve the above objective, the technical solution of the present invention provides an electrostatic spraying device, including: a high-voltage electrostatic generator configured for generating high-voltage static electricity, wherein the high-voltage electrostatic generator includes a positive output terminal and a negative output terminal; a charging electrode connected to the positive output terminal or the negative output terminal of the high-voltage electrostatic generator, wherein the charging electrode is configured for directly contacting a liquid to be sprayed and applying electrostatic charges to the liquid to be sprayed; and an ionizing emitting electrode connected to the negative output terminal or the positive output terminal of the high-voltage electrostatic generator, wherein the ionizing emitting electrode is configured for ionizing the surrounding air to realize an ionizing grounding.

Further, the electrostatic spraying device also includes an ionizing emitting head. The ionizing emitting head includes an insulating shell and an emitting electrode inserting hole (ie inserting hole) for connecting the ionizing induction emitting electrode (ie ionizing emitting electrode), so that the ionizing emitting electrode is connected to the negative output terminal or the positive output terminal of the high-voltage electrostatic generator through the ionizing emitting head.

Further, the electrostatic spraying device includes a liquid storage tank for storing the liquid to be sprayed and a base arranged below the liquid storage tank, and the ionizing emitting head is mounted on the base.

Further, the ionizing emitting electrode adopts a metal single-needle structure or a carbon fiber multi-needle structure.

Further, an electrode protection cover is also arranged surrounding the ionizing emitting head, and the electrode protection cover is made of an insulating material.

Further, the electrostatic spraying device also includes an energy storage capacitor, and the energy storage capacitor is arranged between the high-voltage electrostatic generator and the ionizing emitting head, and configured for storing energy of high-voltage static electricity output by the high-voltage electrostatic generator and then transmitting to the ionizing emitting head.

Further, a sealed insulating plug-in member is respectively arranged between the high-voltage electrostatic generator and the energy storage capacitor and between the energy storage capacitor and the ionizing emitting head. The sealed insulating plug-in member is externally wrapped with rubber and plastic and internally provided with a metal plug connector.

Further, the ionizing emitting electrode adopts a Teflon carbon fiber silicone wire, and the ionizing emitting electrode is connected to the negative output terminal of the high-voltage electrostatic generator.

Further, the electrostatic spraying device includes a spraying head for atomizing and spraying droplets with electrostatic charges. The effective height at which the ionizing emitting electrode away from the ground can be randomly set within the range between 0 m and 3 m, and the radial distance between the spraying head and the ionizing induction emitting electrode (ie ionizing emitting electrode) is greater than 30 cm.

The technical solution of the present invention further provides an electrostatic spraying method, including: applying electrostatic charges to the liquid to be sprayed in a direct contact manner by the charging electrode connected to the positive output terminal or the negative output terminal of the high-voltage electrostatic generator; and ionizing the surrounding air by the ionizing induction emitting electrode (ie ionizing emitting electrode) connected to the negative output terminal or the positive output terminal of the high-voltage electrostatic generator to achieve the ionizing grounding.

### BRIEF DESCRIPTION OF THE DRAWINGS

FIG. 1 is a structural schematic diagram of an electrostatic spraying device according to an embodiment of the present invention;

FIG. 2 is a structural schematic diagram of the ionizing emitting head of an electrostatic spraying device according to an embodiment of the present invention;

FIG. 3A and FIG. 3B are structural schematic diagrams of the ionizing emitting electrode of an electrostatic spraying device according to an embodiment of the present invention;

FIG. 4A, FIG. 4B and FIG. 4C show diagrams demonstrating test effects according to an embodiment of the present invention.

### DETAILED DESCRIPTION OF THE EMBODIMENTS

The technical solutions of the present invention will be further described below in conjunction with specific embodiments, but the present invention is not limited to these embodiments.

The technical solution of the present invention provides an electrostatic spraying device, including: a high-voltage electrostatic generator configured for generating high-voltage static electricity and including a positive output terminal and a negative output terminal; a charging electrode connected to the positive output terminal or the negative output terminal of the high-voltage electrostatic generator and configured for directly contacting a liquid to be sprayed and applying electrostatic charges to the liquid to be sprayed; and an ionizing emitting electrode connected to the negative output terminal or the positive output terminal of the high-voltage electrostatic generator and configured for ionizing the surrounding air to realize an ionizing grounding.

Further, the electrostatic spraying device also includes an ionizing emitting head. The ionizing emitting head includes an insulating shell and an emitting electrode inserting hole (ie inserting hole) for connecting the ionizing induction emitting electrode (ie ionizing emitting electrode), so that the ionizing emitting electrode is connected to the negative output terminal or the positive output terminal of the high-voltage electrostatic generator through the ionizing emitting head.

Further, the electrostatic spraying device includes a liquid storage tank for storing the liquid to be sprayed and a base arranged below the liquid storage tank, and the ionizing induction emitting head is mounted on the base.

Further, the ionizing emitting electrode adopts a metal single-needle structure or a carbon fiber multi-needle structure.

Further, an electrode protection cover is also arranged surrounding the ionizing emitting head, and the electrode protection cover is made of an insulating material.

Further, the electrostatic spraying device includes an energy storage capacitor, and the energy storage capacitor is arranged between the high-voltage electrostatic generator and the ionizing emitting head, and configured for storing energy of high-voltage static electricity output by the high-voltage electrostatic generator and then transmitting to the ionizing emitting head.

Further, a sealed insulating plug-in member is respectively arranged between the high-voltage electrostatic generator and the energy storage capacitor and between the energy storage capacitor and the ionizing emitting head. The sealed insulating plug-in member is externally wrapped with rubber and plastic and internally provided with a metal plug connector.

Further, the ionizing emitting electrode adopts a Teflon carbon fiber silicone wire, and the ionizing emitting electrode is connected to the negative output terminal of the high-voltage electrostatic generator.

Further, the electrostatic spraying device includes a spraying head for atomizing and spraying droplets with electrostatic charges. The height at which the ionizing emitting electrode away from the ground can be randomly set within the range between 0 m and 3 m, and the radial distance between the spraying head and the ionizing emitting electrode is greater than 30 cm.

Further, the voltage of the high-voltage electrostatic generator ranges from 25,000 volts to 35,000 volts.

Further, the ionizing emitting head is arranged in the middle position of the electrode protection cover, and the height at which the electrode protection cover is set is 1.5 cm higher than the ionizing emitting electrode.

The technical solution of the present invention further provides an electrostatic spraying method, including: applying electrostatic charges to the liquid to be sprayed by the charging electrode connected to the positive output terminal or the negative output terminal of the high-voltage electrostatic generator; and ionizing the surrounding air by the ionizing emitting electrode connected to the negative output terminal or the positive output terminal of the high-voltage electrostatic generator, so as to achieve the ionizing grounding by conducting the charged air to the ground or the target.

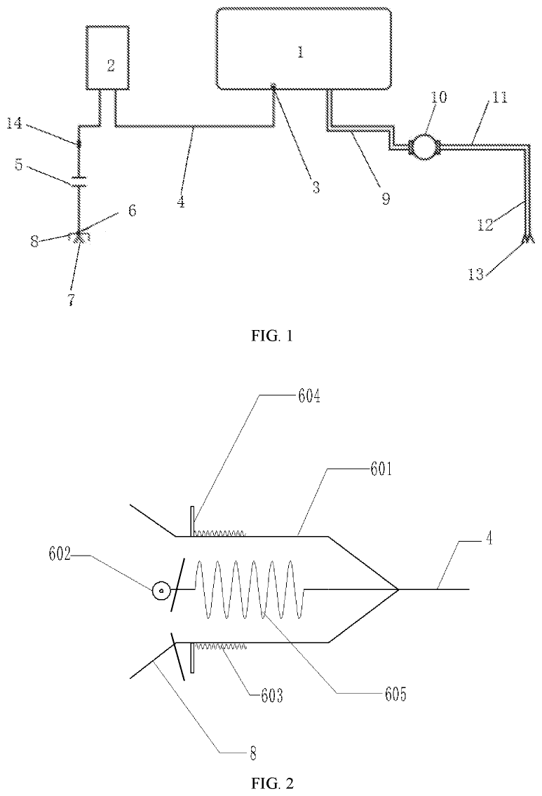

Referring to FIG. 1, the electrostatic spraying device of the present invention includes: the high-voltage electrostatic generator 2 configured for generating high-voltage static electricity and including a positive output terminal and a negative output terminal; the charging electrode 3 connected to the positive output terminal or the negative output terminal of the high-voltage electrostatic generator 2 and configured for directly contacting a liquid to be sprayed and applying electrostatic charges to the liquid to be sprayed; and the ionizing emitting electrode 7 connected to the negative output terminal or the positive output terminal of the high-voltage electrostatic generator 2 and configured for ionizing the surrounding air to realize an ionizing grounding.

In FIG. 1, although the charging electrode 3 is installed in the liquid storage tank 1, the position where the charging electrode 3 is specifically mounted is not limited, as long as the charging electrode can be in contact with the liquid to be sprayed. For example, the charging electrode can also be installed in a liquid conveying pipeline.

According to the above technical solution of the present invention, the high-voltage static electricity of one polarity output by the high-voltage electrostatic generator 2 is connected to the charging electrode 3 made of copper and stainless steel through the high-voltage-resistant wire 4 to charge the liquid, as a result, the liquid charged with the electrostatic charges of one polarity enters the water pump 10 through the liquid conveying pipeline, followed by being pressurized by the water pump 10, passing through the spraying rod 11 and the spraying head 12, and being atomized at the hole of the spraying mouth 13 to spray fine droplets with the electrostatic charges. The high-voltage static electricity of another polarity output by the high-voltage electrostatic generator 2 is conducted to the ionizing emitting electrode 7 through the high-voltage-resistant wire 4, the discharge of the tip of the ionizing emitting electrode 7 enables the surrounding humid air to be ionized and charged, and then conducted to the ground and the target through the charged humid air, so as to realize the formation of a closed current loop of the electrostatic spraying.

In a specific embodiment, in order to enhance the emission strength of the ionizing emitting electrode 7, the energy storage enhancing capacitor (ie energy storage capacitor) 5 can be further arranged in a transmission line. The capacitor 5 selects a high-voltage-resistant large-capacity capacitor to store a relatively high electrostatic current for being strongly emitted and output by the emitting electrode.

In addition, in order to facilitate the installation and assembly of the system, a sealed insulating plug-in member can be arranged in the transmission line. The plug-in member is externally wrapped with rubber and plastic and internally provided with a metal plug connector. This can facilitate a quick connection of high-voltage lines while ensuring high voltage does not leak. For example, the sealed insulating plug-in member 14 may be provided on the line between the high-voltage electrostatic generator 2 and the energy storage capacitor 5, or the sealed insulating plug-in member may be provided on the transmission line between the energy storage capacitor 5 and the emitting electrode 7.

In order to ensure the air ionization effect to achieve the ionizing grounding of the ionizing emitting electrode 7, the output voltage of the high-voltage electrostatic generator 2 is greater than 10,000 volts. Considering the ionization effect and safety, the output voltage of the high-voltage electrostatic generator 2 is preferably between 25,000 volts and 35,000 volts. In addition, after conducting repeated tests by the applicant, the height at which the ionizing emitting electrode 7 away from the ground is preferably between 0 m and 3 m, and the radial distance between the emitting electrode 7 and the spraying head 12 is preferably greater than 30 cm.

Regarding the ionizing emitting electrode 7, its installation method and installation location are not specifically limited. In a specific embodiment, in order to facilitate the installation and fixation of the ionizing emitting electrode 7, the ionizing emitting head 6 may be further provided. FIG. 2 shows a specific structure of the ionizing emitting head 6. The ionizing emitting head 6 includes the insulating shell 601 and the inserting hole 602 provided in the shell 601 for connecting the emitting electrode 7. The emitting electrode inserting hole (ie inserting hole) 602 is connected to the high-voltage-resistant wire 4, so that the ionizing emitting electrode 7 is connected to the negative output terminal or the positive output terminal of the high-voltage electrostatic generator 2 through the ionizing emitting head 6.

In a specific embodiment, the installation and fixation of the ionizing emitting electrode 7 is achieved by installing or fixing the ionizing emitting head 6. For example, the ionizing induction emitting head 6 may be installed on a side or bottom of the liquid storage tank 1. Preferably, the ionizing emitting head 6 can be installed on the tank base of a sprayer. Specifically, a hole can be formulated on the base to receive the emitting head, and the emitting head 6 can be screwed for fixation via the thread 603 on the emitting head.

In addition, the mounting stopper 604 may be further arranged on the emitting head 6. In order to further enhance the emission strength of the ionizing emitting electrode 7, the energy storage coil 605 can be further provided at the front end of the inserting hole 602.

In a further embodiment, in order to further ensure the operation safety in practice use and guide the ionization effect of the ionizing emitting electrode 7, the electrode protection cover 8 can also be provided surrounding the emitting head 6, as shown in FIG. 1 and FIG. 2. The electrode protection cover 8 is made of an insulating material, an opening of the electrode protection cover 8 faces downward, and the emitting head 6 is located in the middle position. Preferably, the electrode protection cover 8 is located at a position about 1.5 cm higher than the top position of the emitting electrode 7, as a result, the emitting and discharge of the tip of the emitting electrode 7 will not be affected, and meanwhile an operator will not accidentally touch the emitting electrode 7 which causes stimulation during operation.

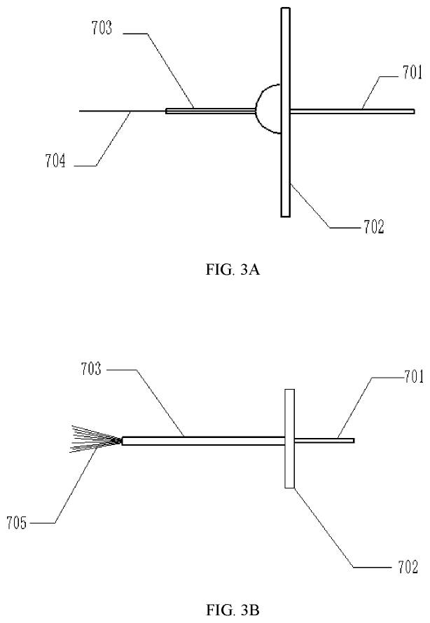

Regarding the ionizing emitting electrode 7, it can adopt either a metal single-needle structure as shown in FIG. 3A, or a carbon fiber multi-needle structure as shown in FIG. 3B.

Referring to FIG. 3A and FIG. 3B, the ionizing emitting electrode 7 may include the plug 701, the mounting stopper 702, the insulating shell 703, and the single metal needle 704 or a plurality of carbon fiber needles 705. The plug 701 can be used to be inserted into the electrode inserting hole (ie inserting hole) 602 of the emitting head 6 described above. The mounting stopper 702 limits the mounting depth to facilitate installation in place.

In a preferred embodiment, the ionizing emitting electrode 7 is connected to the negative output terminal of the high-voltage electrostatic generator 2 to be able to release a large amount of negative ions during operation, thereby conducive to the physical health of an operator. Furthermore, in order to achieve a better releasing effect of negative ions, the ionizing emitting electrode 7 preferably adopts the carbon fiber multi-needle structure. Specifically, the ionizing emitting electrode 7 can adopt a Teflon carbon fiber silicone wire, and the wire is composed of thousands of fine carbon fiber filaments, which is equivalent to thousands of tips at the top of the emitting electrode being discharging, thereby effectively improving the efficiency of ionized discharge.

A further embodiment of the present invention also provides an electrostatic spraying method, including: applying electrostatic charges to the liquid to be sprayed by the charging electrode connected to the positive output terminal or the negative output terminal of the high-voltage electrostatic generator; and ionizing the surrounding air by the ionizing emitting electrode connected to the negative output terminal or the positive output terminal of the high-voltage electrostatic generator to achieve the ionizing grounding.

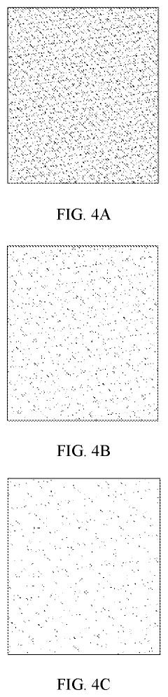

In order to verify the ionizing grounding effect and the all-over spraying effect of the electrostatic spraying device and the electrostatic spraying method according to the present invention, repeated tests are conducted by the applicant. Tests have proved that the all-over adsorption effect of spray according to the technical solutions of the present invention is very perfect. Specifically in the tests, the spraying head 12 is respectively arranged at a height 0.5 m, 1 m and 2 m higher than the target; the ionizing emitting head 7 is respectively arranged at a height 0.5 m, 1 m and 2.5 m away from the ground; and the distance between the ionizing emitting head 7 and the target is respectively 0.5 m, 5 m and 10 m. FIG. 4(A)-(C) respectively show the all-over adsorption effects of spray on the target under the above-mentioned conditions.

The above descriptions are only the preferred embodiments of the present invention. It should be pointed out that for those of ordinary skill in the art, without departing from the inventive concept of the present invention, several modifications and improvements can be made, and these all belong to the protection scope of the present invention.

1. An electrostatic spraying device, wherein the electrostatic spraying device comprises:
a high-voltage electrostatic generator configured for generating high-voltage static electricity, wherein the high-voltage electrostatic generator comprises a positive output terminal and a negative output terminal;
a charging electrode connected to the positive output terminal or the negative output terminal of the high-voltage electrostatic generator, wherein the charging electrode is configured for directly contacting a liquid to be sprayed and applying electrostatic charges to the liquid to be sprayed; and
an ionizing emitting electrode connected to the negative output terminal or the positive output terminal of the high-voltage electrostatic generator, wherein the ionizing emitting electrode is configured for ionizing the surrounding air to realize an ionizing grounding.

2. The electrostatic spraying device according to claim 1, wherein the electrostatic spraying device further comprises an ionizing emitting head, the ionizing emitting head comprises an insulating shell and an emitting electrode inserting hole for connecting the ionizing emitting electrode, so that the ionizing emitting electrode is connected to the negative output terminal or the positive output terminal of the high-voltage electrostatic generator through the ionizing emitting head.

3. The electrostatic spraying device according to claim 2, wherein the electrostatic spraying device further comprises a liquid storage tank for storing a liquid to be sprayed and a base arranged below the liquid storage tank, and the ionizing emitting head is mounted on the base.

4. The electrostatic spraying device according to claim 3, wherein the ionizing emitting electrode adopts a metal single-needle structure or a carbon fiber multi-needle structure.

5. The electrostatic spraying device according to claim 4, wherein an electrode protection cover is further arranged surrounding the ionizing emitting head, and the electrode protection cover is made of an insulating material.

6. The electrostatic spraying device according to claim 1, wherein the electrostatic spraying device further comprises an energy storage capacitor, and the energy storage capacitor is arranged between the high-voltage electrostatic generator and the ionizing emitting head, and configured for storing energy of high-voltage static electricity output by the high-voltage electrostatic generator and then transmitting to the ionizing emitting head.

7. The electrostatic spraying device according to claim 6, wherein a sealed insulating plug-in member is further arranged between the high-voltage electrostatic generator and the energy storage capacitor and between the energy storage capacitor and the ionizing emitting head, respectively, and the sealed insulating plug-in member is externally wrapped with rubber and plastic and internally provided with a metal plug connector.

8. The electrostatic spraying device according to claim 7, wherein the ionizing emitting electrode adopts a Teflon carbon fiber silicone wire, and the ionizing emitting electrode is connected to the negative output terminal of the high-voltage electrostatic generator.

9. The electrostatic spraying device according to claim 1, wherein the electrostatic spraying device comprises a spraying head for atomizing and spraying droplets with electrostatic charges, an effective height at which the ionizing induction emitting electrode away from the ground is randomly set within the range between 0 m and 3 m, and a radial distance between the spraying head and the ionizing emitting electrode is greater than 30 cm.

10. An electrostatic spraying method, wherein the electrostatic spraying method comprises:
applying electrostatic charges to a liquid to be sprayed in a direct contact manner by a charging electrode connected to a positive output terminal or a negative output terminal of a high-voltage electrostatic generator; and
ionizing the surrounding air by an ionizing emitting electrode connected to the negative output terminal or the positive output terminal of the high-voltage electrostatic generator to achieve an ionizing grounding.
